(19) United States
(12) Patent Application Publication
(10) Pub. No.: US 2022/0366909 A1
(43) Pub. Date: Nov. 17, 2022

(54) INFORMATION PROCESSING APPARATUS AND COMMAND PROCESSING METHOD

(71) Applicant: Sony Group Corporation, Tokyo (JP)

(72) Inventors: Hiro IWASE, Tokyo (JP); Yuhei TAKI, Tokyo (JP); Kunihito SAWAI, Tokyo (JP)

(73) Assignee: Sony Group Corporation, Tokyo (JP)

(21) Appl. No.: 17/762,087

(22) PCT Filed: Oct. 16, 2020
(86) PCT No.: PCT/JP2020/039178

§ 371 Date: Mar. 21, 2022

(30) Foreign Application Priority Data
Oct. 30, 2019 (JP) 2019-197973

(51) Int. Cl. G10L 15/22; G10L 15/02; G10L 25/90; G06F 3/14; G06V 40/16; G10L 15/25

(52) U.S. Cl. CPC G10L 15/22; G10L 15/02; G10L 25/90; G06F 3/14; G06V 40/166; G10L 15/25; G10L 2015/223; G10L 2015/025

(57) ABSTRACT

An acoustic feature detection unit (31) detects acoustic features of voice discretely input separately from a command instructing movement of an operation target. A movement control unit (32) controls the movement of the operation target instructed by the command on the basis of the acoustic features detected by the acoustic feature detection unit (31).

### FIELD

The present invention relates to an information processing apparatus and a command processing method.

### BACKGROUND

There is known a technique of receiving an input of a command by voice, recognizing the received voice, and performing processing corresponding to the recognition result. For example, Patent Literature 1 proposes a technique of receiving an input of a command by voice and continuing processing of the command according to the length of the ending of the voice.

### CITATION LIST

### Patent Literature

Patent Literature 1: JP 2016-99479 A

### SUMMARY

### Technical Problem

However, in the technique described in Patent Literature 1, in a case where processing of the command is to be continued, it is necessary to utter the ending of the voice for a long time, and the operation load on the user may be high.

Thus, the present disclosure proposes an information processing apparatus and a command processing method capable of performing processing of a command while reducing the operation load.

### Solution to Problem

According to the present disclosure, the information processing apparatus includes an acoustic feature detection unit and a movement control unit. The acoustic feature detection unit detects acoustic features of voice discretely input separately from a command instructing movement of an operation target. The movement control unit controls the movement of the operation target instructed by the command on the basis of the acoustic features detected by the acoustic feature detection unit.

### BRIEF DESCRIPTION OF DRAWINGS

FIG. 1 is a diagram illustrating a configuration example of an information processing system according to an embodiment of the present disclosure.

FIG. 2 is a diagram illustrating a functional configuration example of the information processing system according to the embodiment of the present disclosure.

FIG. 3 is a diagram illustrating an example of voice operation on an operation target according to the embodiment of the present disclosure.

FIG. 4 is a diagram illustrating an example of a UI model according to the embodiment of the present disclosure.

FIG. 5 is a diagram illustrating flick movement according to the embodiment of the present disclosure.

FIG. 6 is a diagram illustrating a change in speed according to a change in pitch according to the embodiment of the present disclosure.

FIG. 7A is a diagram illustrating switching of an acceleration/deceleration model according to the embodiment of the present disclosure.

FIG. 7B is a diagram illustrating switching of an acceleration/deceleration model according to the embodiment of the present disclosure.

FIG. 8 is a diagram illustrating an example of display of an operation target according to the present disclosure.

FIG. 9A is a diagram illustrating an example of display of an operation target according to the present disclosure.

FIG. 9B is a diagram illustrating an example of display of an operation target according to the present disclosure.

FIG. 9C is a diagram illustrating an example of display of an operation target according to the present disclosure.

FIG. 10 is a diagram illustrating an example of display of an operation target according to the present disclosure.

FIG. 11 is a diagram illustrating a determination example of the operation types according to the embodiment of the present disclosure.

FIG. 12A is a diagram illustrating another example of an operation target according to the embodiment of the present disclosure.

FIG. 12B is a diagram illustrating another example of an operation target according to the embodiment of the present disclosure.

FIG. 12C is a diagram illustrating another example of an operation target according to the embodiment of the present disclosure.

FIG. 12D is a diagram illustrating another example of an operation target according to the embodiment of the present disclosure.

FIG. 13 is a flowchart illustrating acoustic feature operation reception start processing according to the embodiment of the present disclosure.

FIG. 14 is a flowchart illustrating acoustic feature operation reception end processing according to the embodiment of the present disclosure.

FIG. 15 is a flowchart illustrating operation target state monitoring processing according to the embodiment of the present disclosure.

FIG. 16 is a flowchart illustrating acoustic feature operation processing according to the embodiment of the present disclosure.

FIG. 17A is a flowchart illustrating operation type determination processing in a determination method A according to the embodiment of the present disclosure.

FIG. 17B is a flowchart illustrating operation type determination processing in a determination method B according to the embodiment of the present disclosure.

FIG. 17C is a flowchart illustrating operation type determination processing in a determination method C according to the embodiment of the present disclosure.

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

In addition, the present disclosure will be described according to the following item order.

1-1. Introduction

1-2. Overview of Embodiment

2-1. Configuration of Information Processing System According to Embodiment

2-2. Specific Examples

2-3. Flow of Processing According to Embodiment

3. Effects of Embodiment

### 1-1. Introduction

The technique of Patent Literature 1 receives input of a command by voice, and continues processing of the command according to the length of the ending of the voice. For example, in a case of scrolling the screen to the right by voice, the user utters “Right ( [symbol] )” with a long ending until a desired position is displayed. However, the user has to utter a long ending until a desired position is displayed, and the operation load may be high.

### 1-2. Overview of Embodiment

Thus, in the present embodiment, the movement of the operation target instructed by the command is controlled on the basis of acoustic features of voice discretely input separately from the command instructing the movement. As a result, it is not necessary to continue the utterance of the command, and thus, it is possible to perform the processing of the command while reducing the operation load.

The overview of the present embodiment has been described above, and the present embodiment will be described in detail below.

### 2-1. Configuration of Information Processing System According to Embodiment

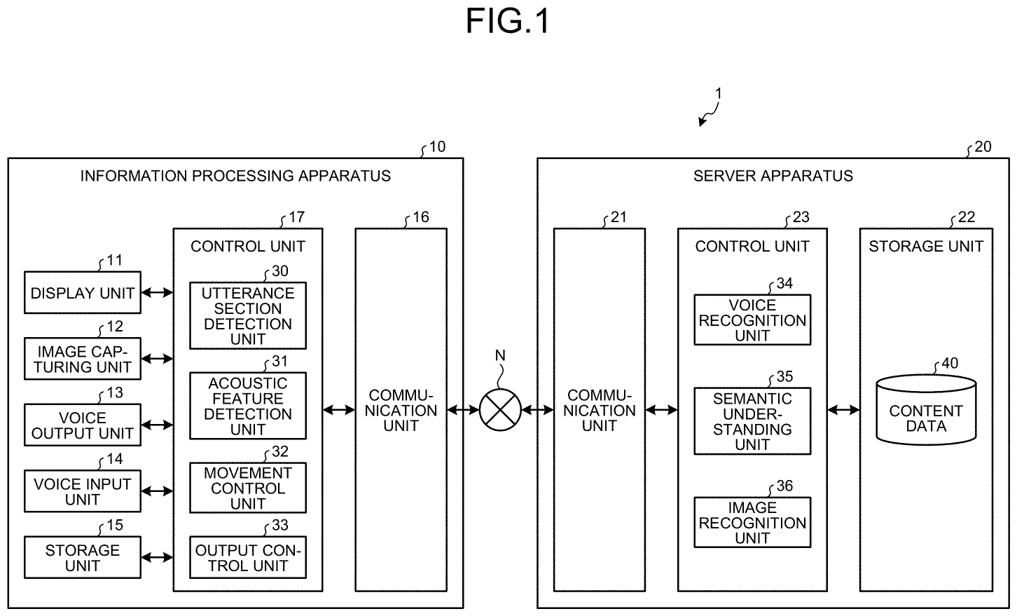

With reference to FIG. 1, a configuration of an information processing system 1 including an information processing apparatus 10 that is an example of an information processing apparatus that performs information processing according to the embodiment and a server apparatus 20 will be described. FIG. 1 is a diagram illustrating a configuration example of the information processing system 1 according to the embodiment of the present disclosure. The information processing system 1 is a system that provides an input of a command by voice.

The information processing apparatus 10 is an information processing terminal that receives an input of a command by voice from the user for an operation target having a temporal change. The information processing apparatus 10 may be a personal computer, or a portable terminal such as a smartphone or tablet terminal carried by the user. In the present embodiment, the information processing apparatus 10 corresponds to the information processing apparatus according to the present disclosure.

The server apparatus 20 is a server apparatus that performs recognition processing of a command input by voice.

First, a configuration of the information processing apparatus 10 will be described. As illustrated in FIG. 1, the information processing apparatus 10 includes a display unit 11, a photographing unit 12, a voice output unit 13, a voice input unit 14, a storage unit 15, a communication unit 16, and a control unit 17. Note that the information processing apparatus 10 may include an input unit (for example, a keyboard, a mouse, or the like) that receives various operations from a user or the like who uses the information processing apparatus 10.

The display unit 11 is a display device that displays various types of information. Examples of the display unit 11 include display devices such as a liquid crystal display (LCD) and a cathode ray tube (CRT). The display unit 11 displays various types of information under the control of the control unit 17. For example, the display unit 11 displays a screen displaying an operation target.

The photographing unit 12 is an image capturing device such as a camera. The photographing unit 12 photographs an image on the basis of control from the control unit 17, and outputs photographed image data to the control unit 17.

The voice output unit 13 is an acoustic output device such as a speaker. The photographing unit 12 outputs various sounds on the basis of control from the control unit 17.

The voice input unit 14 is a sound collecting device such as a microphone. The photographing unit 12 collects user's voice and the like, and outputs collected voice data to the control unit 17.

The storage unit 15 is implemented by, for example, a semiconductor memory device such as a random access memory (RAM) or a flash memory, or a storage device such as a hard disk or an optical disk. The storage unit 15 stores various programs including control programs for controlling acoustic feature operation reception end processing, operation target state monitoring processing, acoustic feature operation processing, and operation type determination processing described later. In addition, the storage unit 15 stores various data.

The communication unit 16 is implemented by, for example, a network interface card (NIC) or the like. The communication unit 16 is connected to a network N (the Internet or the like) in a wired or wireless manner, and transmits and receives information to and from the server apparatus 20 or the like via the network N.

The control unit 17 is implemented by, for example, a central processing unit (CPU), a micro processing unit (MPU), or the like executing a program stored inside the information processing apparatus 10 by using a random access memory (RAM) or the like as a work area. In addition, the control unit 17 may be a controller, and may be implemented by, for example, an integrated circuit such as an application specific integrated circuit (ASIC) or a field programmable gate array (FPGA).

Next, a configuration of the server apparatus 20 will be described. As illustrated in FIG. 1, the server apparatus 20 includes a communication unit 21, a storage unit 22, and a control unit 23. Note that the server apparatus 20 may include an input unit (for example, a keyboard, a mouse, or the like) that receives various operations from a user or the like who uses the server apparatus 20, and a display unit (for example, a liquid crystal display or the like) for displaying various types of information.

The communication unit 21 is implemented by, for example, an NIC or the like. The communication unit 21 is connected to the network N in a wired or wireless manner, and transmits and receives information to and from the information processing apparatus 10 and the like via the network N.

The storage unit 22 is implemented by, for example, a semiconductor memory device such as a RAM or a flash memory, or a storage device such as a hard disk or an optical disk. The storage unit 22 stores various programs. In addition, the storage unit 22 stores various data. For example, the storage unit 22 stores content data 40.

The content data 40 is data in which contents such as music and video are stored.

The control unit 23 is implemented by, for example, a CPU, an MPU, or the like executing a program or the like stored inside the server apparatus 20 as a work area. In addition, the control unit 17 may be a controller, and may be implemented by, for example, an integrated circuit such as an ASIC or an FPGA.

In the present embodiment, the control unit 17 of the information processing apparatus 10 and the server apparatus 20 control unit 23 perform processing in a distributed manner, thereby performing processing of a command recognized from voice. For example, the control unit 17 includes an utterance section detection unit 30, an acoustic feature detection unit 31, a movement control unit 32, and an output control unit 33, and the control unit 23 includes a voice recognition unit 34, a semantic understanding unit 35, and an image recognition unit 36, thereby implementing or executing functions and operations of information processing described below. Note that the control unit 17 and the control unit 23 are not limited to the configurations illustrated in FIG. 1, and may have other configurations as long as functions and operations of information processing described below can be implemented.

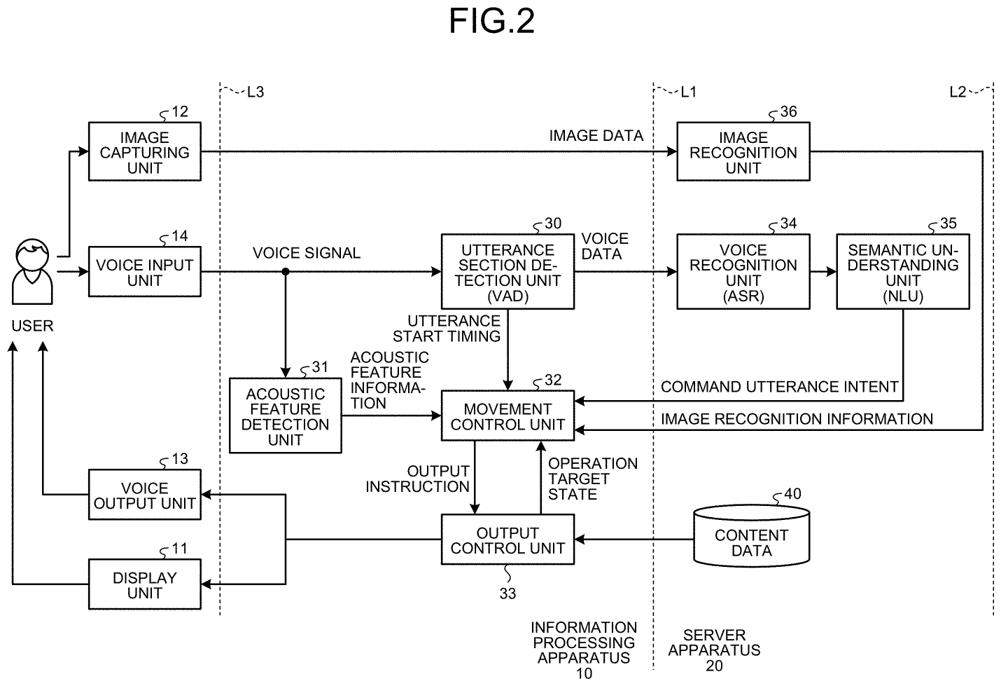

FIG. 2 is a diagram illustrating a functional configuration example of the information processing system 1 according to the embodiment of the present disclosure. In FIG. 2, the left side of a broken line L1 is components on the information processing apparatus 10 side, and the right side of the broken line L1 is components on the server apparatus 20 side. Note that the boundary between the components of the information processing apparatus 10 and the server apparatus 20 is not limited to the broken line L1. The utterance section detection unit 30, the acoustic feature detection unit 31, the movement control unit 32, the output control unit 33, the voice recognition unit 34, the semantic understanding unit 35, the image recognition unit 36, and the content data 40 may be components of either the information processing apparatus 10 side or the server apparatus 20 side. For example, the boundary between the components of the information processing apparatus 10 and the server apparatus 20 may be a broken line L2, and all the components may be on the information processing apparatus 10 side. In addition, the boundary between the components of the information processing apparatus 10 and the server apparatus 20 may be a broken line L3, and all the components may be on the server apparatus 20 side. In this case, the server apparatus 20 corresponds to the information processing apparatus according to the present disclosure.

The voice uttered by the user is input to the information processing system 1 through the voice input unit 14. The voice input unit 14 A/D converts the input voice into voice data, and outputs the converted voice data to the utterance section detection unit 30 and the acoustic feature detection unit 31.

The utterance section detection unit 30 detects an utterance section by performing voice section detection (voice activity detection (VAD)) on the input voice data, and outputs the voice data in the utterance section to the voice recognition unit 34.

The acoustic feature detection unit 31 detects acoustic features of the voice from the input voice data. Examples of the acoustic features include presence or absence of a specific phoneme, a maximum volume of a specific phoneme, a vocalization start interval of a specific phoneme, a pitch of a specific phoneme, a rising/falling polarity of a pitch, and a change amount of a pitch. In addition, examples of the acoustic features include an onomatopoeia, a strength of a strained sound, a fricative, a volume of a fricative, and a tongue clicking sound. The acoustic feature detection unit 31 detects acoustic features from the input voice data by signal processing or a neural network having learned acoustic features. In a case where an acoustic feature is detected, the acoustic feature detection unit 31 outputs acoustic feature information indicating the detected acoustic feature to the movement control unit 32.

The voice recognition unit 34 performs voice recognition (automatic speech recognition (ASR)) processing on the voice data detected as the utterance section in the voice section detection, and converts the voice data into text data. As a result, the user's voice input to the voice input unit 14 is converted into a text. The semantic understanding unit 35 performs semantic understanding processing such as natural language understanding (NLU) on the text data converted by the voice recognition unit 34, and estimates an utterance intent (Intent+Entity). The semantic understanding unit 35 outputs utterance intent information indicating the estimated utterance intent to the movement control unit 32.

The image of the user is input to the information processing system 1 through the photographing unit 12. The photographing unit 12 periodically photographs an image and outputs photographed image data to the image recognition unit 36. The image recognition unit 36 performs face recognition or line-of-sight recognition on the input image data, performs recognition of the recognized face direction of the face or line of sight, and outputs image recognition information indicating a recognition result to the movement control unit 32.

The output control unit 33 outputs the contents of the content data 40 to the user through the voice output unit 13 and the display unit 11 on the basis of the output instruction from the movement control unit 32.

The movement control unit 32 receives the acoustic feature information from the acoustic feature detection unit 31, the utterance intent information from the semantic understanding unit 35, and the image recognition information from the image recognition unit 36. In addition, the movement control unit 32 acquires the state of the operation target from the output control unit 33. For example, the movement control unit 32 acquires the position and the moving speed of the operation target. The movement control unit 32 performs quantitative movement control of the operation target on the basis of the acoustic feature information input from the acoustic feature detection unit 31, the utterance intent information input from the semantic understanding unit 35, and the image recognition information input from the image recognition unit 36, and performs output instruction to the output control unit 33. The movement control unit 32 controls the movement of the operation target instructed by the command on the basis of the acoustic features of the voice discretely input separately from the command. For example, the movement control unit 32 controls the moving speed of the operation target on the basis of the acoustic features discretely input. In the present embodiment, the movement control unit 32 can perform flick movement of cumulatively accelerating the operation target and moving the operation target to the destination by inertia while frictionally decelerating the operation target, tap stop of immediately stopping the operation target, and drag correction of moving the operation target at a fixed speed while the voice of the acoustic feature continues.

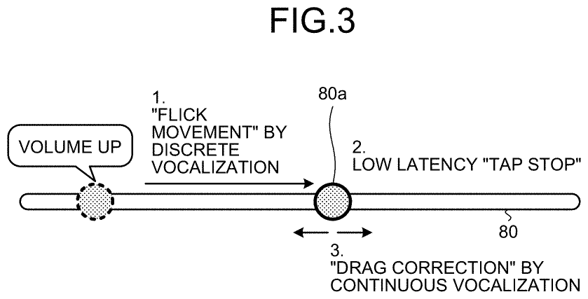

As a result, it is possible to perform the processing of the command while reducing the operation load. FIG. 3 is a diagram illustrating an example of voice operation on an operation target according to the embodiment of the present disclosure. FIG. 3 illustrates a volume indicator 80 for adjusting the volume as an operation target. The volume indicator 80 is provided with a slider bar 80a indicating the volume. The volume indicator 80 can operate the volume by moving the slider bar 80a. In addition, in the volume indicator 80, the slider bar 80a moves according to the operation of the volume by voice. FIG. 3 illustrates a user interface (UI) behavior when the volume indicator 80 is operated. The operation by an acoustic feature is started with the utterance of the user “Volume up ( [symbol] )” as a trigger. First, the user performs flick movement by discrete vocalization. As a result, it is possible to move the slider bar 80a to the vicinity of the target volume with a low load in a short time. During the movement, the user performs tap stop by specific phonological vocalization or acoustic feature change at a position where the user wants to stop the movement. As a result, it is possible to immediately stop with low latency. When the played sound heard at the stop position of the tap stop is not the target volume, the user performs drag correction by continuous vocalization and finely adjusts the volume until the volume reaches the target volume.

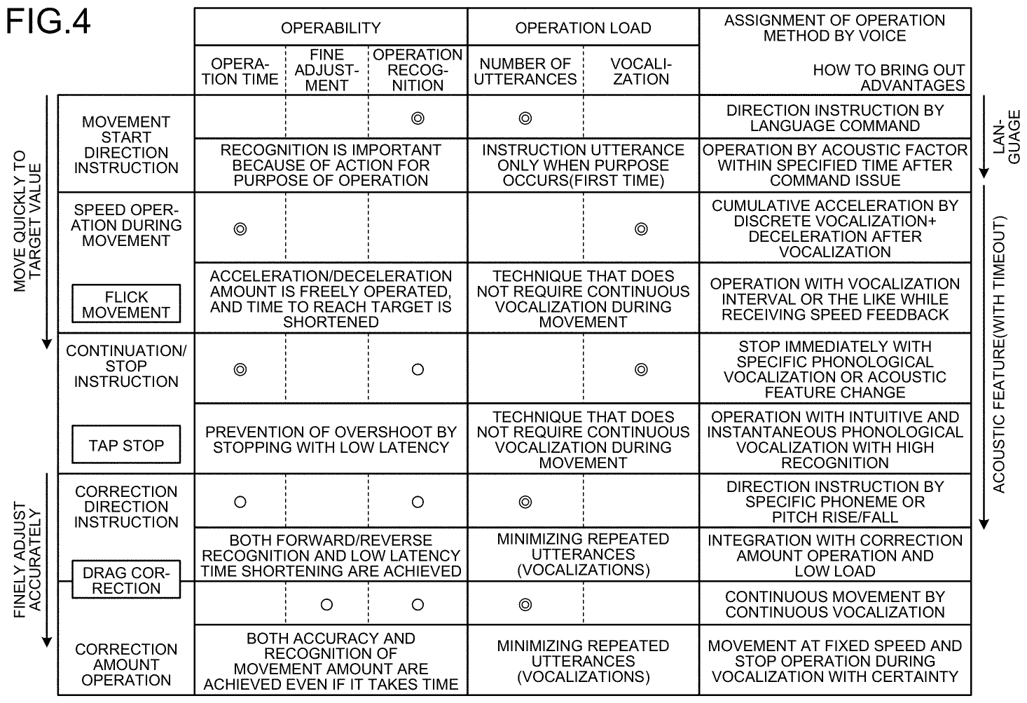

The UI behavior illustrated in the example of FIG. 3 is performed on the basis of the assignment of the operation methods by voice of the entire UI model illustrated in FIG. 4. FIG. 4 is a diagram illustrating an example of a UI model according to the embodiment of the present disclosure. In FIG. 4, the operation is decomposed in five stages in the column direction of the table, and five trade-off factors regarding the operability and the operation load are described in the row direction of the table. The trade-off factor having a large influence (to be regarded as important) on each decomposed operation is described inside the table of FIG. 4, and the assignment of the operation methods by voice is performed on the basis of the influence. In order to implement this UI model, it is necessary to provide a flick movement method of operating the moving speed by voice while achieving both shortening of the operation time and reduction of the vocalization load, and a method of determining each method of flick movement, tap stop, and drag correction from the acoustic features of the voice with low latency. Details of these methods will be described later.

### 2-2. Specific Examples

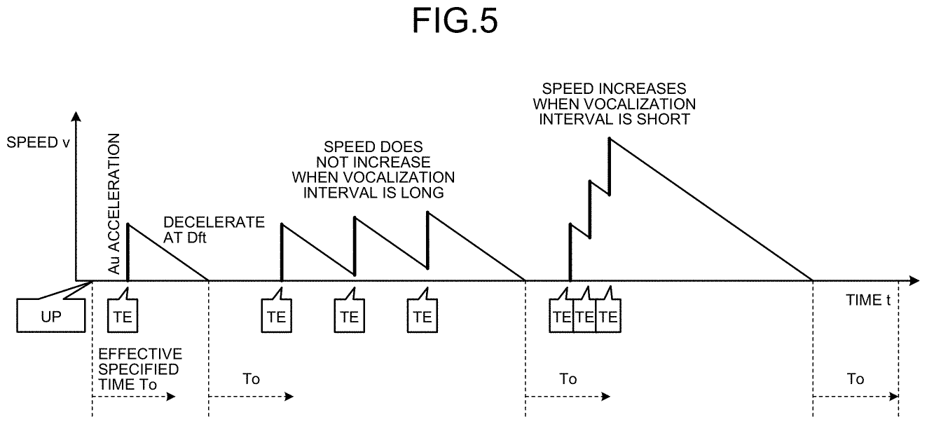

Hereinafter, how to implement voice operation on the operation target according to the embodiment will be described by using specific examples. First, the flick movement will be described. FIG. 5 is a diagram illustrating flick movement according to the embodiment of the present disclosure. FIG. 5 illustrates the timing of the voice operation and the change in the moving speed v of the operation target over time.

The utterance section detection unit 30 detects an utterance section of the input voice data, and outputs the voice data in the utterance section to the voice recognition unit 34. The voice recognition unit 34 performs voice recognition processing on the voice data input from the utterance section detection unit 30, and converts the voice data into text data. The semantic understanding unit 35 performs semantic understanding processing on the text data converted by the voice recognition unit 34, and outputs utterance intent information indicating the estimated utterance intent to the movement control unit 32. For example, in FIG. 5, the semantic understanding unit 35 estimates the utterance intent of the utterance “Up ( [symbol] )” as volume-up and outputs utterance intent information of utterance intent “Intent=VolumeUp” to the movement control unit 32.

On the other hand, the acoustic feature detection unit 31 detects acoustic features of voice discretely input separately from the command instructing the movement of the operation target. The acoustic feature detection unit 31 detects a first acoustic feature and a second acoustic feature different from the first acoustic feature from discretely input voice.

The movement control unit 32 controls the movement of the operation target instructed by the command on the basis of the acoustic features detected by the acoustic feature detection unit 31. In a case where the first acoustic feature is detected, the movement control unit 32 increases the moving speed of the operation target. In addition, the movement control unit 32 frictionally decelerates the operation target while the first acoustic feature and the second acoustic feature are not detected. In addition, in a case where the second acoustic feature is detected, the movement control unit 32 performs control to stop the operation target.

For example, the acoustic feature detection unit 31 detects acoustic features of the voice from input voice data. In FIG. 5, the acoustic feature detection unit 31 detects a phoneme “Te ( [symbol] )” as a first acoustic feature from the input voice data and outputs acoustic feature information to the movement control unit 32.

In a case where the utterance intent indicated by the input utterance intent information is a command related to a movement operation, the movement control unit 32 starts to receive an operation by an acoustic feature input from the acoustic feature detection unit 31. In a case where the first acoustic feature is detected, the movement control unit 32 increases the moving speed of the operation target. For example, in FIG. 5, since the acoustic feature “Te ( [symbol] )” is provided, the movement control unit 32 adds the speed Au to the moving speed Vc before the operation of the operation target as expressed in the following equation (1) to accelerate the operation target to the moving speed v.

v=Vc+Au (1)

where:

Vc is the moving speed (before acceleration) of the operation target at the time of vocalization.

Au is the added speed.

In addition, the movement control unit 32 frictionally decelerates the operation target while the first acoustic feature and the second acoustic feature are not detected. The movement control unit 32 gradually decelerates the moving speed v of the operation target until the moving speed v of the operation target becomes zero at the time of non-vocalization when acoustic features are not input during the movement of the operation target. For example, the movement control unit 32 measures the elapsed time t at the time of non-vocalization from the timing at which the moving speed v of the operation target is finally accelerated. The movement control unit 32 subtracts the frictional deceleration Df×t from the moving speed vo of the operation target at the elapsed time t=0 according to the elapsed time t as expressed in the following equation (2), and gradually decelerates the moving speed v of the operation target until the moving speed v of the operation target becomes zero.

Moving speed of operation target:

v=vo−Df×t (2)

where:

vo is the moving speed of the operation target at the elapsed time t=0.

Df is the frictional deceleration.

The movement control unit 32 enables an operation by an acoustic feature for a period of a predetermined effective time To after the command instructing the movement of the operation target is input, and times out and disables the acoustic feature operation if no operation is performed in this period. The effective time To is a time during which an acoustic feature can be regarded as being uttered following the command. For example, the effective time To is set to two seconds. When an operation by an acoustic feature is performed during the period of the effective time To and the operation target moves, the movement control unit 32 always enables the acoustic feature operation during the movement. In addition, when the operation target stops, the movement control unit 32 enables the acoustic feature operation the acoustic feature operation for the period of the effective time To, and times out and disables the acoustic feature operation if no operation is performed in this period.

For example, in FIG. 5, when the user utters “Up ( [symbol] )” and the movement control unit 32 receives the utterance intent information of the utterance intent “Intent=VolumeUp” from the semantic understanding unit 35, the movement control unit 32 starts to receive an operation by an acoustic feature. When the discrete vocalization “Te ( [symbol] )” is detected during the period of the effective time To, the movement control unit 32 cumulatively adds the moving speed of the operation target. As illustrated in FIG. 5, when “Te ( [symbol] )” is uttered during the period of the effective time To after “Up ( [symbol] )” is uttered, the moving speed v is accelerated to the speed Au and then slowly decelerated at the frictional deceleration Df.

In addition, when the vocalization interval of “Te ( [symbol] )” is long, acceleration is repeated after the moving speed v decreases, so that the moving speed v does not get so high. On the other hand, when the vocalization interval of “Te ( [symbol] )” is short, acceleration is repeated before the moving speed v decreases, so that the moving speed v gets high. That is, the shorter the interval of the vocalization of the first acoustic feature is, the faster the moving speed of the operation target gets, and the longer the vocalization interval is, the slower the moving speed of the operation target gets. As a result, the user can control the moving speed of the operation target by the vocalization interval.

Note that the speed Au added to the moving speed Vc of the operation target expressed in the above equation (1) may be a fixed value or may be a variable value according to the acoustic feature. For example, at the timing when detection of a specific phoneme is started, the operation target may be accelerated according to the equation (1) with the speed Au as the fixed speed Ac as expressed in the following equation (3).

Au=Ac (3)

In addition, the movement control unit 32 may change the positive or negative polarity of the speed Ac depending on the type of phoneme. For example, the movement control unit 32 may set the speed Ac to a positive value and accelerate the operation target in the same direction as that of the command utterance instruction in a case of a sound “Te ( [symbol] )”, and may set the speed Ac to a negative value and accelerate the operation target in the opposite direction to that of the command utterance instruction in a case of a sound “Ki ( [symbol] )”. In addition, for example, the movement control unit 32 may set the polarity of the speed Ac by detecting a tongue clicking sound (for example, a “Chin ( [symbol] )” sound, or a “Con ( [symbol] )” sound in which a tongue is placed on a lower jaw) or detecting an exhalation sound/inspiration sound of a fricative.

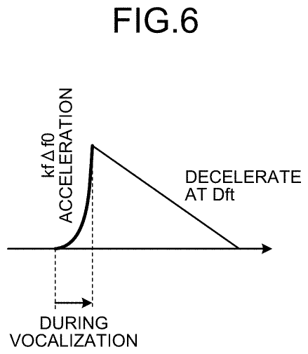

In addition, the movement control unit 32 may change the speed Au according to a change in the pitch from the vocalization start of the detected vocalization. FIG. 6 is a diagram illustrating a change of the speed Au according to a change in the pitch according to the embodiment of the present disclosure. For example, the movement control unit 32 may obtain and add the speed Au proportional to the change amount from the fundamental frequency f0 of the pitch from the utterance start of the voice detected as the acoustic feature as expressed in the following equation (4). During the continuation of the vocalization, the cumulative addition is continued such as “Te ( [symbol] )”, “Te ( [symbol] )”, and “Te ( [symbol] )” on the right side of FIG. 5.

Au=kf×Δf0 (4)

where:

Δf0 is a pitch change amount from the utterance start.

kf is a conversion coefficient from the pitch change amount to the added speed.

The pitch change amount Δf0 has a positive or negative polarity according to the rise/fall of the pitch. For example, at the time of pitch rise, the pitch change amount Δf0 has a positive value. In this case, the operation target accelerates in the direction same as the direction of the command instruction. At the time of pitch fall, the pitch change amount Δf0 has a negative value. In this case, the operation target accelerates in a direction opposite to the direction of the command instruction.

In addition, the movement control unit 32 may change the speed Au according to the volume during discrete vocalization. For example, the movement control unit 32 may obtain and add the speed Au proportional to the maximum volume Vu during discrete vocalization as expressed in the following equation (5).

Au=kv×Vu (5)

where:

Vu is a maximum value of an input volume (for example, root mean square (RMS)) in a unit time during discrete vocalization or a peak value of the voice signal.

kv is a conversion coefficient from the maximum volume to the added speed.

In addition, the movement control unit 32 may add a speed proportional to the intensity of detection of the strained voice (vocal fry) or the maximum value of the volume of the exhalation sound/inspiration sound (the speed at which the person exhales/inhales).

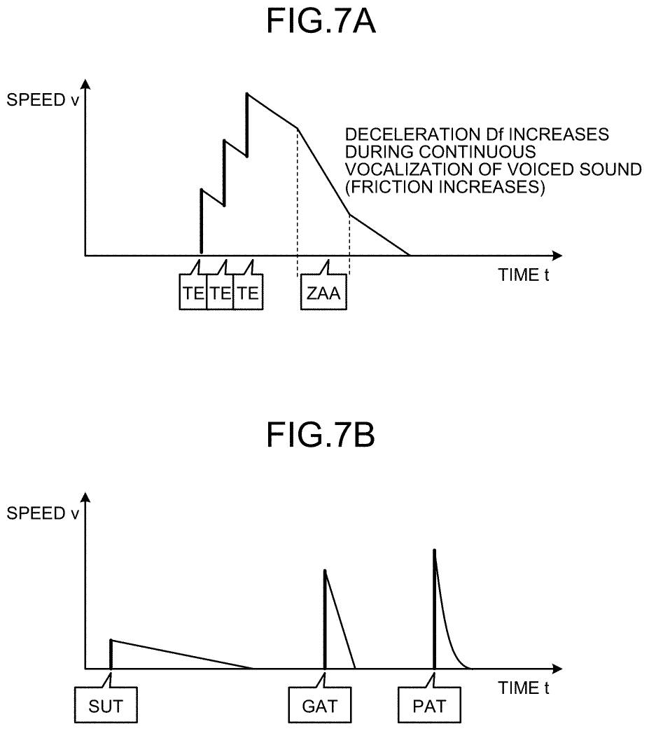

In addition, the acceleration/deceleration model may be switched according to an onomatopoeia of an uttered phoneme. For example, the acoustic feature detection unit 31 detects an onomatopoeia expressing friction as the acoustic feature. The movement control unit 32 may switch the acceleration/deceleration model according to the detected onomatopoeia. FIG. 7A is a diagram illustrating switching of the acceleration/deceleration model according to the embodiment of the present disclosure. FIG. 7A illustrates the timing of the voice operation and the change in the moving speed v at which the operation target moves over time. The acoustic feature detection unit 31 detects a voiced sound expressing friction as an onomatopoeia expressing friction. Examples of the voiced sound expressing friction include, in the case of Japanese, “zaa ( [symbol] )” and “zuu ( [symbol] )”, and in the case of English, the voiced sounds that start with “z” and “g”. In a case where a voiced sound for increasing friction is detected while the operation target is moving, the movement control unit 32 increases the frictional deceleration Df during the vocalization of the voiced sound. In the example of FIG. 7A, during the utterance of “zaa ( [symbol] )”, the frictional deceleration Df increases, and the degree of decrease in the moving speed v of the operation target increases.

In addition, the acceleration/deceleration model may be switched according to the type of the onomatopoeia of the uttered phoneme. FIG. 7B is a diagram illustrating switching of the acceleration/deceleration model according to the embodiment of the present disclosure. FIG. 7B illustrates the timing of the voice operation and the change in the moving speed v at which the operation target moves over time. The acoustic feature detection unit 31 detects an onomatopoeia expressing a movement state as an acoustic feature. In the case of Japanese, examples of the onomatopoeia expressing the movement state include “sut ( [symbol] )” as an onomatopoeia for gently pushing and smoothly moving, “gat ( [symbol] )” as an onomatopoeia for strongly pushing and moving at a time, and “pat ( [symbol] )” as an onomatopoeia for moving instantaneously. In addition, in the case of English, examples of the onomatopoeia expressing the movement state include “s(mooth)” as an onomatopoeia for gently pushing and smoothly moving, “ba(m)” as an onomatopoeia for moving instantaneously, and “po(p)” as an onomatopoeia for moving instantaneously. In a case where an onomatopoeia expressing a movement state is detected, the movement control unit 32 switches the acceleration/deceleration model according to the type of the onomatopoeia. In the example of FIG. 7B, in a case where “sut ( [symbol] )” is detected, the movement control unit 32 sets the speed Au and the frictional deceleration Df to small values, and gently pushes the operation target so as to move smoothly. In addition, in a case where “gat ( [symbol] )” is detected, the movement control unit 32 sets the speed Au and the frictional deceleration Df to large values, and strongly pushes the operation target so as to move at a time. In addition, in a case where “pat ( [symbol] )” is detected, the movement control unit 32 sets the speed Au to a large value while gradually decreases the frictional deceleration Df from a large value, and instantaneously moves the operation target while gently moving the operation target at a low speed. The movement control unit 32 may set the movement amount the same but the behavior of speed different depending on the type of the onomatopoeia expressing the movement state. In addition, the speed Au may be changed depending on the maximum value of the volume of the acoustic feature or the pitch change amount from the utterance start.

By the way, operation by acoustic feature is weak against noise, and may erroneously react and behave differently from the user's intention in a case where there is a plurality of persons around.

Thus, in the present embodiment, a measure of providing an effective time To (for example, To=two seconds) in which a movement operation by an acoustic feature is effective with the utterance of the language command as a trigger is taken as a method for temporal noise reduction. Note that, in the present embodiment, the utterance of the command is used as the start trigger of an operation by an acoustic feature, but the present invention is not limited thereto. The command may be input by a gesture. For example, the image recognition unit 36 performs image recognition on an image photographed by the photographing unit 12 and recognizes a command from a gesture. The movement control unit 32 may execute the command recognized by the image recognition unit 36. The movement control unit 32 may use the timing at which the command is recognized as a start trigger of the acoustic feature operation. Examples of the gesture indicating the command include, as a movement start direction instruction, a tilt of the neck, a direction of the face, and a pointing direction of a hand. In addition, the end of the movement operation may be input by a gesture. For example, the image recognition unit 36 performs image recognition on an image photographed by the photographing unit 12 and recognizes a gesture indicating the end of the movement operation. When the gesture indicating the end of the movement operation is recognized by the image recognition unit 36, the movement control unit 32 may end the effective time To. Examples of the gesture indicating the end of the movement operation include nodding and an OK sign with a hand.

In addition, as a noise countermeasure based on characteristics of human vocalization, in detection of each acoustic feature in the acoustic feature detection unit 31, erroneous detection may be reduced by performing the following processing. For example, there is a limit to a short time interval of vocalization when a person utters discretely. Thus, the acoustic feature detection unit 31 may detect discrete vocalization at a time interval longer than or equal to that of discrete vocalization of a person. For example, the acoustic feature detection unit 31 may determine, for specific phonemes, whether the time interval of detection starts is a certain value (for example, 100 ms) or greater, and detect specific phonemes for which the time interval of the detection starts is a certain value or greater.

In addition, for example, human vocal cords have a range of voice in which continuous change can be made. Thus, the acoustic feature detection unit 31 may detect acoustic features only in a range of voice in which continuous change can be made by a person. For example, the acoustic feature detection unit 31 may detect acoustic features when the unit time change amount Δf0 of the pitch is less than a threshold (for example, one act (octave)), and may not detect acoustic features and not perform cumulative acceleration when the unit time change amount Δf0 is greater than or equal to the threshold.

In addition, in order to increase noise resistance, the acoustic feature detection unit 31 may detect acoustic features only from those recognized as human utterance by voice characteristic recognition or the like, or those whose speakers are further identified. The movement control unit 32 may recognize the user who has instructed the command related to a movement of the operation target and limit the reaction only to the voice of the recognized user. The user may be identified by voice recognition or may be identified by image recognition processing of an image captured by the photographing unit 12.

In addition, in order to distinguish whether the user intends to perform an operation, determination by line of sight may be made such as whether the user is looking at the operation target. For example, the movement control unit 32 determines whether the user is looking at the display unit 11 from at least one of the direction of the face and the line of sight recognized by the image recognition unit 36 when the command is input. In a case where the user is looking at the display unit 11, the movement control unit 32 performs processing according to the acoustic feature. For example, the image recognition unit 36 detects the face direction and the line of sight of the user by image recognition processing of an image around the device captured by the photographing unit 12. The movement control unit 32 determines whether the user's utterance is directed to the information processing system 1 from the face direction or the line of sight detected by the image recognition unit 36. For example, in a case where the detected face direction or line of sight is directed in the direction of the display unit 11, the movement control unit 32 determines that the utterance is directed to the information processing system 1. In a case where the face direction or the line of sight is directed in the direction of the display unit 11, the movement control unit 32 performs processing according to the acoustic feature.

In addition, the following processing may be added to the above-described noise countermeasures to further reduce noise and prevent erroneous detection. The voice input unit 14 may perform beamforming in the utterance direction of the command and receive acoustic features only for vocalization from the same direction as the utterance direction of the command that has been the start trigger of the acoustic feature operation. In addition, the acoustic feature detection unit 31 may perform calibration for learning arbitrary vocalization phonemes in advance. For example, the acoustic feature detection unit 31 may prevent an erroneous reaction due to erroneous detection of a filler or stammering by detecting arbitrary phonemes set by the user. In addition, the acoustic feature detection unit 31 may identify the voice characteristic of an individual and may not receive voice of other people. The movement control unit 32 may receive acoustic features only in a case where the phonological recognition result from the shape of the mouth obtained by the image recognition by the image recognition unit 36 matches the phonological detection result obtained from the acoustic feature detection unit 31.

Incidentally, it is difficult to understand how far the operation target reaches in the flick movement.

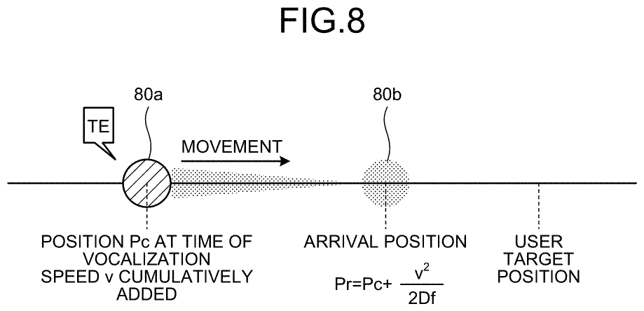

Thus, the display unit 11 may display an arrival point to be reached by the movement operation of the operation target. FIG. 8 is a diagram illustrating an example of display of an operation target according to the present disclosure. FIG. 8 illustrates a volume indicator 80 for adjusting the volume. In the volume indicator 80, the slider bar 80a moves according to the operation of the volume by voice. FIG. 8 illustrates a case where, after the command of the right movement operation is recognized, “Te ( [symbol] )” is uttered during the period of the effective time To. The output control unit 33 may obtain the arrival point from the moving speed at the time of vocalization of the acoustic feature and display the arrival point on the display unit 11. For example, the output control unit 33 obtains an arrival point Pr from the moving speed v cumulatively added by “Te ( [symbol] )” from the following equation (6). Then, the output control unit 33 displays a marker 80b at the position of the arrival point Pr on the display unit 11.

Pr=Pc+(v×v/Df)/2=Pc+v²/(2×Df) (6)

where:

Pc is the position at the time of vocalization.

As a result, the user can see the marker 80b at the arrival point Pr with respect to the target position and grasp whether the target position of the user is reached.

In a case where the moving speed v is changed by the cumulative addition of the vocalization pitch change amount, the output control unit 33 obtains the arrival point Pr from the changing moving speed v as needed, and displays the marker 80b of the arrival point Pr on the display unit 11 following the change in the moving speed v.

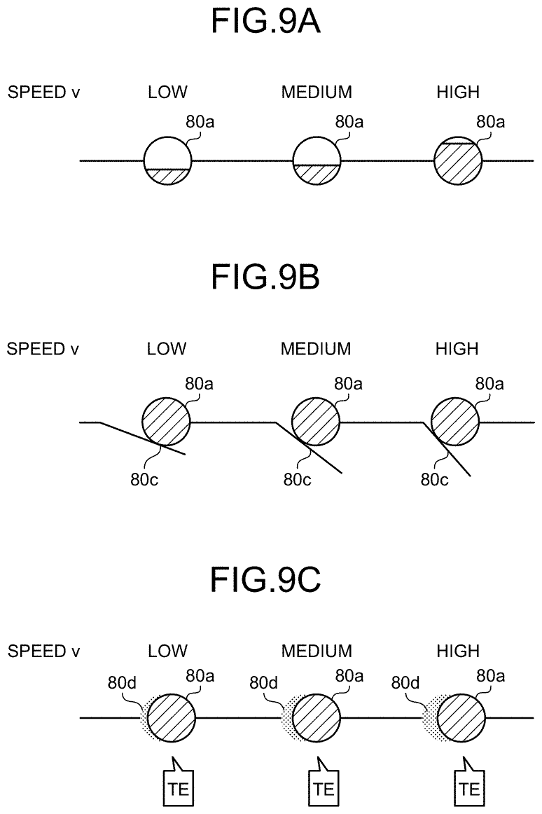

In addition, the display unit 11 may display the moving speed of the operation target. For example, the output control unit 33 may display a GUI indicating the moving speed v cumulatively added at the time of vocalization on the display unit 11. FIGS. 9A to 9C are diagrams illustrating examples of display of an operation target according to the present disclosure. FIGS. 9A to 9C illustrate the slider bar 80a that is provided in the above-described volume indicator 80 and indicates the volume. The slider bar 80a moves according to the operation of the volume by voice. FIG. 9A illustrates a case where the moving speed v is displayed as the charge amount inside the slider bar 80a. The moving speed v is visually presented by filling the inside of the slider bar 80a as the moving speed v increases. FIG. 9B illustrates a case where the moving speed v is displayed by the tilt of a tangent 80c in contact with the slider bar 80a. The moving speed v is visually presented by tilting the tangent 80c as the moving speed v increases. FIG. 9C illustrates a case where a shadow 80d is displayed on the slider bar 80a and the moving speed v is displayed with a stereoscopic effect. The moving speed v is visually presented by shifting the shadow 80d from the slider bar 80a to increase the stereoscopic effect of the slider bar 80a as the moving speed v increases.

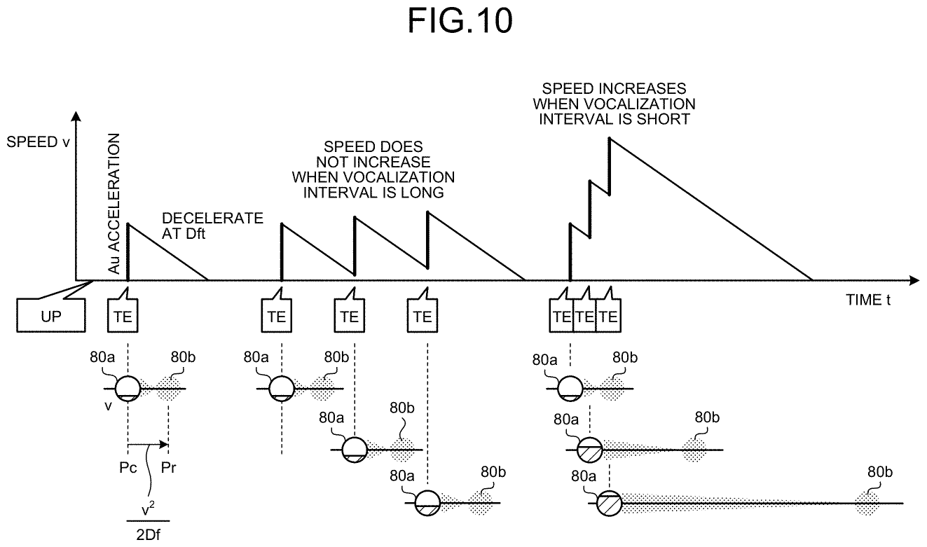

FIG. 10 is a diagram illustrating an example of display of an operation target according to the present disclosure. FIG. 10 illustrates the slider bar 80a that is provided in the above-described volume indicator 80 and indicates the volume. FIG. 10 illustrates a case where the arrival point is displayed by the marker 80b and the moving speed v of the slider bar 80a is displayed in the flick movement illustrated in FIG. 5. In FIG. 10, the moving speed v cumulatively added at the time of uttering “Te ( [symbol] )” is displayed as the charge amount inside the slider bar 80a. In addition, the marker 80b is displayed at the arrival point Pr at the moving speed v cumulatively added at the time of uttering “Te ( [symbol] )”. In a case where the moving speed v changes by cumulative addition of vocalization of a plurality of “Te ( [symbol] )”, the position of the marker 80b changes following the moving speed v.

Next, tap stop and drag correction will be described. The tap stop and the drag correction are performed when acoustic features different from those of the flick movement are detected. The acoustic feature detection unit 31 detects a second acoustic feature different from the first acoustic feature from discretely input voice. In a case where the second acoustic feature is detected, the movement control unit 32 performs control to stop the operation target. In addition, the acoustic feature detection unit 31 detects a third acoustic feature different from the first acoustic feature and the second acoustic feature from discretely input voice. In a case where the third acoustic feature is detected, the movement control unit 32 performs control to move the operation target at a fixed speed or a speed corresponding to the third acoustic feature during the continuation of the voice of the third acoustic feature.

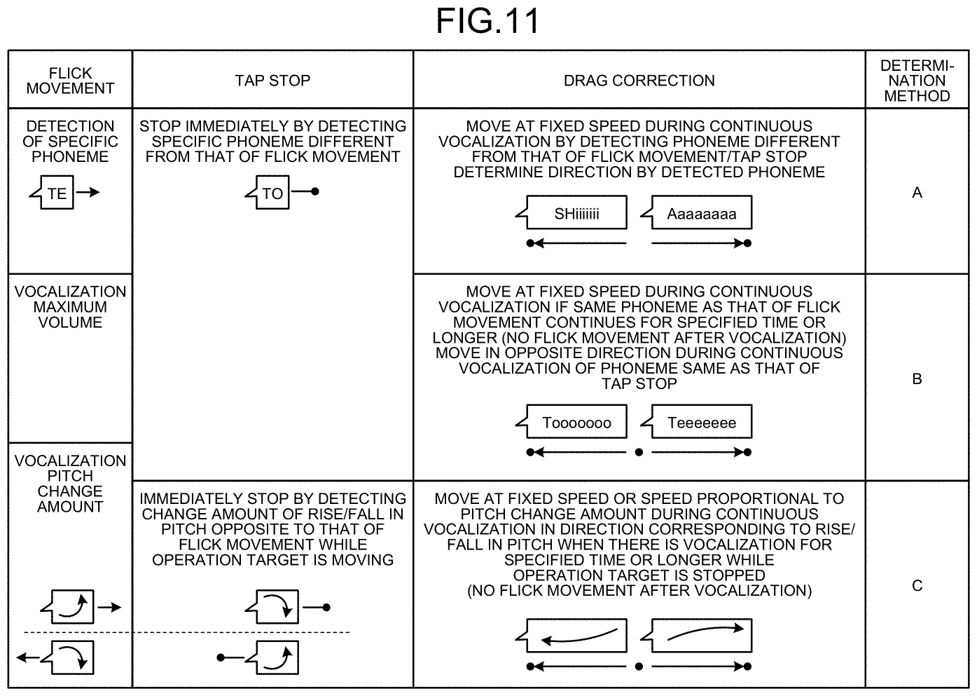

FIG. 11 is a diagram illustrating a determination example of the operation type according to the embodiment of the present disclosure. FIG. 11 illustrates three patterns as examples of the first acoustic feature for performing the flick movement, two patterns as examples of the second acoustic feature for performing the tap stop, and three patterns as examples of the third acoustic feature for performing the drag correction. The flick movement, the tap stop, and the drag correction can be performed by combining patterns of respective acoustic features.

When a second acoustic feature different from the first acoustic feature of the flick movement is detected, tap stop is performed. For example, in the case of flick movement to the right by the detection of a specific phoneme “Te ( [symbol] )”, tap stop (immediate stop) is performed by the detection of a specific phoneme “To ( [symbol] )” different from that of the flick movement. This combination of the patterns of the acoustic features of the flick movement and the tap stop is defined as a determination method A.

In addition, for example, in a case where a speed proportional to the maximum volume Vu or the pitch change amount Δf0 of the specific phoneme “Te ( [symbol] )” is cumulatively added to the moving speed and the flick movement is performed, the tap stop is performed by the detection of the specific phoneme “To ( [symbol] )”. This combination of the patterns of the acoustic features of the flick movement and the tap stop is defined as a determination method B. Note that the tap stop may be performed by detecting an acoustic feature different from that of the flick movement, for example, a tongue clicking sound or an exhalation sound/inspiration sound of a fricative. Note that, in the determination method B, the speed may not be proportional to the maximum volume Vu or the pitch change amount Δf0, and similarly to the determination method A, the flick movement to the right may be performed by the detection of the specific phoneme “Te ( [symbol] )”, and the tap stop may be performed by the detection of the specific phoneme “To ( [symbol] )”.

In addition, for example, in a case where the speed is cumulatively added in the right direction by the rise in the vocalization pitch (Δf0 is a positive value) and the flick movement is performed, the tap stop is performed when the fall in the pitch (Δf0 is a negative value) is detected during the movement in the right direction. Similarly, in a case where the speed is cumulatively added in the left direction by the fall in the vocalization pitch (Δf0 is a negative value) and the flick movement is performed, the tap stop is performed when the rise in the pitch (Δf0 is a positive value) is detected during the movement in the left direction. This combination of the patterns of the acoustic features of the flick movement and the tap stop is defined as a determination method C.

In addition, when a third acoustic feature different from the first acoustic feature of the flick movement and the second acoustic feature of the tap stop is detected, drag correction is performed. For example, in a case where the flick movement and the tap stop are determined by detection of specific phonemes, when d specific phoneme different from the phonemes of the flick movement and the tap stop is detected, drag correction is performed. In the case of the determination method A of FIG. 11, for example, when “Shiiiiiii ( [symbol] )” (left) or “Aaaaaaaa ( [symbol] )” (right) is detected, drag correction is performed in which the operation target moves at a fixed speed during the continuation of the vocalization.

In addition, for example, if Lite same phoneme as that of the flick movement continues for a specified time or longer, drag correction is performed in the direction of the flick movement during the continuation of the vocalization. In addition, if the same phoneme as that of the tap stop continues for a specified time or longer, drag correction is performed in a direction opposite to the direction of the flick movement during the continuation of the vocalization. In the case of the determination method B in FIG. 11, when the same phoneme as that of the phoneme “Te ( [symbol] )” of the flick movement continues for a specified time or longer as “Teeeeeee ( [symbol] )”, the operation target moves in the right direction same as the direction of the flick movement at a fixed speed during the continuation of the vocalization. In addition, when the same phoneme as the phoneme “To ( [symbol] )” that is the same as that of the tap stop continues for a specified time or longer as “Tooooooo ( [symbol] )”, the operation target moves at a fixed speed in the left direction opposite to the direction of the flick movement during the continuation of the vocalization. Note that the drag correction may be performed by detecting acoustic features different from those of the flick movement and the tap stop, for example, a tongue clicking sound or an exhalation sound/inspiration sound of a fricative.

In addition, for example, in the case where the flick movement and the tap stop are determined according to the vocalization pitch change amount, when there is vocalization for a specified time or longer while the operation target is stopped, drag correction is performed in a direction corresponding to the rise or fall of the pitch of the vocalization. In the case of the determination method C of FIG. 11, in a case where there is vocalization for a specified time or longer while the operation target is stopped and the pitch of the vocalization is a rise having the same polarity as that of the flick movement, the operation target moves at a fixed speed or a speed proportional to the pitch change amount in the right direction same as the direction of the flick movement during the continuation of the vocalization. In addition, in a case where the pitch of the vocalization is a fall having the same polarity as that of the tap stop, the operation target moves at a fixed speed or a speed proportional to the pitch change amount in the left direction opposite to the direction of the flick movement during the continuation of the vocalization.

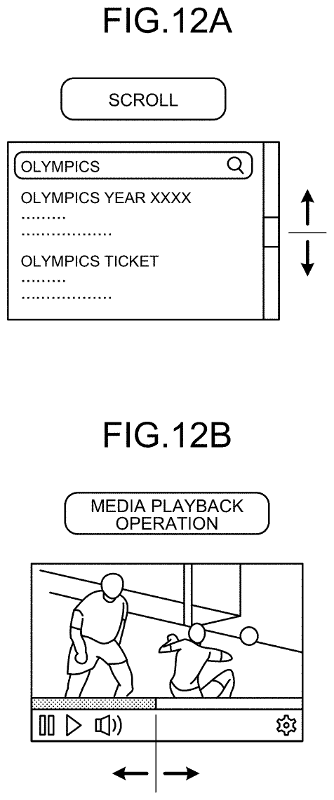

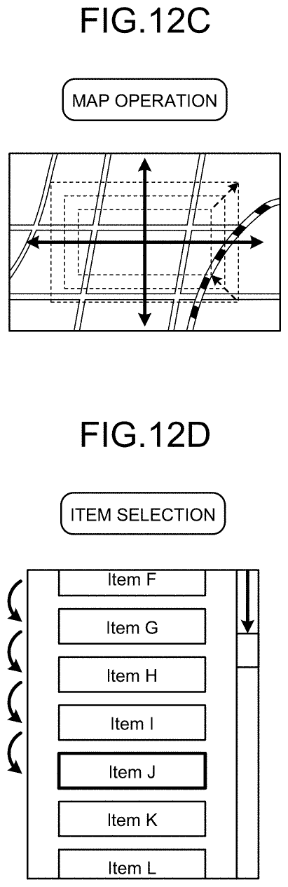

Here, in the present embodiment, the case where the operation target is the volume indicator has been described as an example, but the present invention is not limited thereto. The operation target may be any object as long as the object is operated to move. In addition, the operation target may be continuously operated or may be discretely operated. Examples of the continuous operation target include a scroll operation, an operation related to playback of media such as a video content, a two-dimensional movement or scaling (zoom-in/out) operation of a map, and a media playback control operation such as music and video. In addition, examples of the discrete operation target include an item selection operation and a cover flow for displaying contents such as photographs in a visually flipping form. FIG. 12A is a diagram illustrating another example of the operation target according to the embodiment of the present disclosure. FIG. 12A illustrates a scroll operation in the vertical direction of the screen. The technique of the present disclosure may be applied to a case where a command for a scroll operation is input by using a voice. FIG. 12D is a diagram illustrating another example of the operation target according to the embodiment of the present disclosure. FIG. 12A illustrates an operation of a playback position of media such as image contents. The technique of the present disclosure may be applied to a case where a command for an operation of a playback position is input by using a voice. FIG. 12C is a diagram illustrating another example of the operation target according to the embodiment of the present disclosure. FIG. 12C illustrates two-dimensional movement in the vertical and horizontal directions and a scaling operation of the map displayed on the screen. The technique of the present disclosure may be applied to a case where a command for a two-dimensional movement or a scaling operation of a map is input by using a voice. FIG. 12D is a diagram illustrating another example of the operation target according to the embodiment of the present disclosure. FIG. 12D illustrates item selection for selecting an item to be selected from a plurality of items. The technique of the present disclosure may be applied to a case where a command for item selection is input by using a voice.

In addition, the operation target is not limited to an operation of an object displayed on the screen. For example, examples of the operation target include an operation of stopping while listening to text reading or returning the reading position to the back and reading again, an operation of adjusting the brightness of a light, an operation of adjusting the volume in a device without an indicator display, and an operation of setting the temperature of an air conditioner. In addition, examples of the operation target include destination/waypoint setting on a map of a car navigation system, movement of a viewpoint or an object in a three-dimensional space of virtual reality (VR), and time/clock setting. For a car navigation system, it is difficult to operate by hand while driving, and for VR, it is difficult to operate by hand due to mounting a head mounted display, so that operation by voice using the technique of the present disclosure is effective. In addition, as the operation target, a voice operation using the technique of the present disclosure is effective for a movement operation such as turning pages when an electronic document such as an electronic medical record is displayed in a hospital. For example, in an operating room or the like, operation by hand is difficult, so that operation by voice using the technique of the present disclosure is effective.

In addition, in a case where the arrival point Pr is out of display in a map operation, a scroll operation, or the like, the output control unit 33 may perform utterance indicating the arrival point Pr by speech synthesis (text to speech (TTS)). For example, in the case of a map operation, the place name of the arrival point Pr is uttered. In addition, in the case of an operation of item selection, an item name arranged at the arrival point Pr is uttered.

In addition, when the moving speed of the operation target is too fast, there is a high possibility that the target position is overshot. Thus, the movement control unit 32 may restrict the moving speed of the operation target not to be accelerated to a certain speed or greater. In this case, the movement control unit 32 may lower the frictional deceleration Df for not accelerating the moving speed of the operation target to a certain speed or greater.

In addition, for example, in an operation of a discrete operation target such as item selection, the output control unit 33 may shift the position to an adjacent item so as not to stop between items.

### 2-3. Flow of Processing According to Embodiment

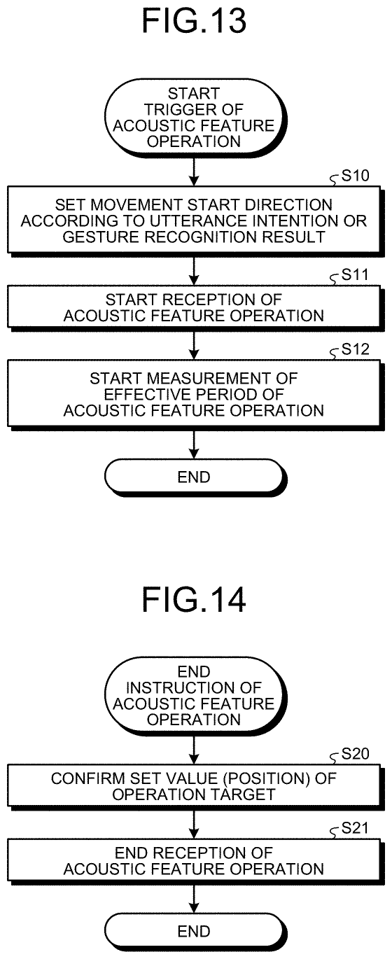

Next, a flow of various types of processing executed in the command processing by the information processing system 1 according to the embodiment will be described. First, acoustic feature operation reception start processing for starting reception of an operation by an acoustic feature will be described. FIG. 13 is a flowchart illustrating the acoustic feature operation reception start processing according to the embodiment of the present disclosure. The acoustic feature operation reception start processing is executed at a timing when a start trigger such as a command instructing movement of the operation target is input. For example, the acoustic feature operation reception start processing is executed in a case where the utterance intent “Intent” of utterance intent information input from the semantic understanding unit 35 is to instruct movement, or in a case where a command recognized from a gesture is to instruct movement.

The movement control unit 32 sets the movement start direction instructed by the utterance intent “Intent” or the command recognized from the gesture (step S10). The movement control unit 32 starts to receive an operation by an acoustic feature (step S11). After setting the effective time To in the timer, the movement control unit 32 starts counting down the timer for the effective time, starts measuring the effective period an operation by an acoustic feature (step S12), and ends the processing.

According to this acoustic feature operation reception start processing, in a case where a command instructing movement is input, reception of an operation by an acoustic feature is started.

Next, acoustic feature operation reception end processing for ending reception of an operation by an acoustic feature will be described. FIG. 14 is a flowchart illustrating the acoustic feature operation reception end processing according to the embodiment of the present disclosure. The acoustic feature operation reception end processing is executed at a timing when the end of the movement operation is input. For example, the acoustic feature operation reception end processing is executed in a case where the end of the movement operation is input by a gesture.

The movement control unit 32 ends the movement of the operation target and confirms the set value (position) (step S20). The movement control unit 32 sets the timer to zero (timeout), ends the reception of an operation by an acoustic feature (step S21), and ends the processing.

According to this acoustic feature operation reception end processing, in a case where the end of the movement operation is instructed, the reception of an operation by an acoustic feature is ended.

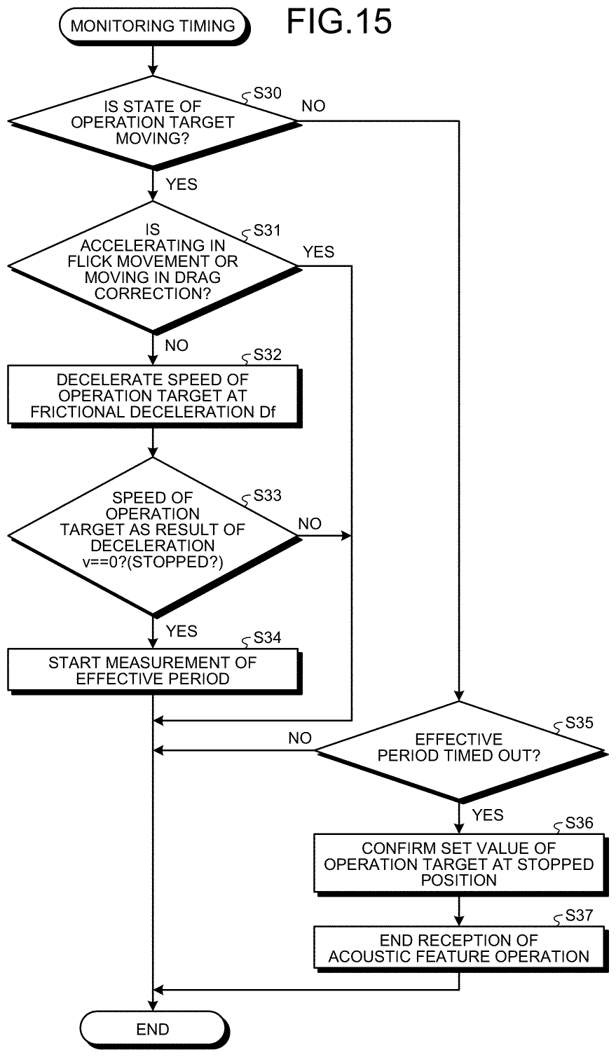

Next, operation target state monitoring processing for monitoring the state of the operation target will be described. FIG. 15 is a flowchart illustrating the operation target state monitoring processing according to the embodiment of the present disclosure. The operation target state monitoring processing is executed at a periodic monitoring timing. For example, the operation target state monitoring processing is repeatedly executed as needed.

The movement control unit 32 determines whether or not the state of the operation target is moving (step S30). In a case where the state of the operation target is moving (step S30: Yes), the movement control unit 32 determines whether or not the operation target is accelerating in the flick movement or moving in the flick correction (step S31). In a case where the operation target is not accelerating in the flick movement or moving in the flick correction (step S31: No), the movement control unit 32 decelerates the moving speed of the operation target at a frictional deceleration Df (step S32). The movement control unit 32 determines whether or not the moving speed of the operation target has become zero (stopped) as a result of the deceleration (step S33). In a case where the moving speed of the operation target has become zero (step S33: Yes), the movement control unit 32 starts a countdown after setting the effective time To in the timer, starts measuring the effective period an operation by an acoustic feature (step S34), and ends the processing.

On the other hand, in a case where the moving speed of the operation target is not zero (step S33: No), the process is ended.

Meanwhile, in a case where the state of the operation target is stopped and not moving (step S30: No), the movement control unit 32 determines whether or not the effective time of the timer has timed out (step S35). In a case where the effective time of the timer has not timed out (step S35: No), the process is ended.

On the other hand, in a case where the effective time of the timer has timed out (step S35: Yes), the movement control unit 32 confirms the set value (position) of the operation target with the stopped set value (position) (step S36). The movement control unit 32 ends the reception of an operation by an acoustic feature (step S37), and the process is ended.

According to this operation target state monitoring processing, in a case where the operation target is moving, frictional deceleration is made until the moving speed becomes zero. In addition, according to the operation target state monitoring processing, when the effective time of the timer has timed out, the reception of an operation by an acoustic feature is ended.

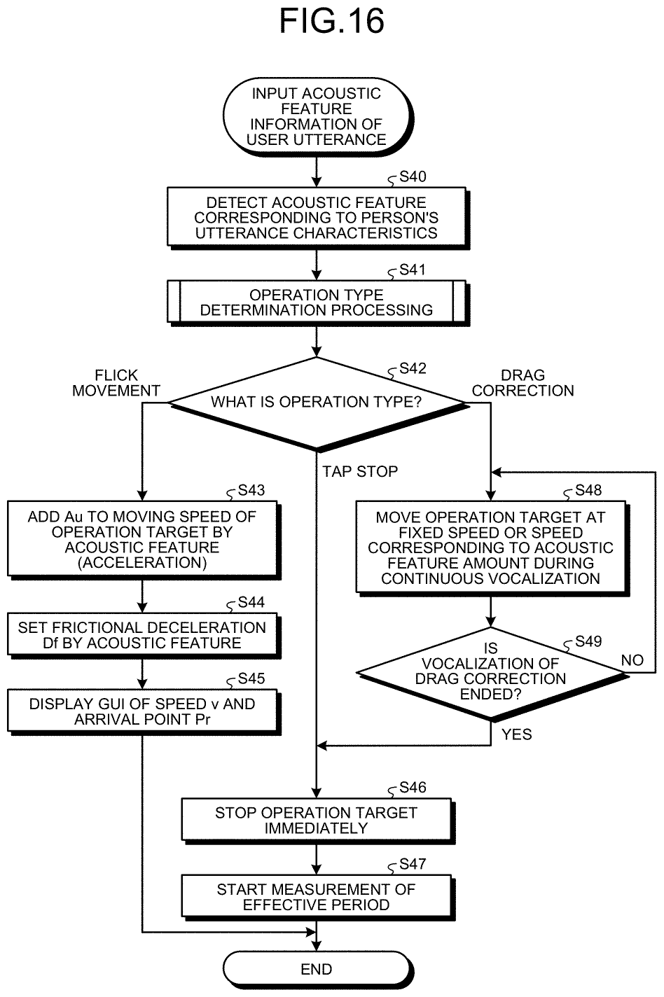

Next, acoustic feature operation processing for operating an operation target by an acoustic feature will be described. FIG. 16 is a flowchart illustrating the acoustic feature operation processing according to the embodiment of the present disclosure. The acoustic feature operation processing is executed at a timing when an acoustic feature is detected within an effective period of an operation by an acoustic feature.

The acoustic feature detection unit 31 detects only acoustic features corresponding to characteristics of human vocalization among detected acoustic features (step S40). For example, the acoustic feature detection unit 31 detects acoustic features of discrete vocalization at a time interval longer than or equal to that of discrete vocalization of a person. In addition, the acoustic feature detection unit 31 detects acoustic features in which the unit time change amount Δf0 of the pitch is less than a threshold (for example, one oct (octave)).

The movement control unit 32 performs operation type determination processing of determining an operation type from the detected acoustic features to determine whether the operation type is flick movement, tap stop, or drag correction (step S41). Details of the operation type determination processing will be described later.

The movement control unit 32 determines whether the specified operation type is flick movement, tap stop, or drag correction (step S42). In a case where the operation type is flick movement, the process proceeds to step S43 described later. In a case where the operation type is tap stop, the process proceeds to step S46 described later. In a case where the operation type is drag correction, the process proceeds to step S48 described later.

In a case where the operation type is the flick movement, the movement control unit 32 sets the speed Au according to the acoustic feature, adds the speed Au to the moving speed Vc before the operation of the operation target, and accelerates the moving speed v of the operation target (step S43). The movement control unit 32 sets the frictional deceleration of according to the acoustic feature (step S44). The output control unit 33 obtains the arrival point Pr from the moving speed v, displays GUIs of the moving speed v and the arrival point Pr on the display unit 11 (step S45), and ends the processing.

Meanwhile, in a case where the operation type is the tap stop, the movement control unit 32 immediately stops the movement of the operation target (step S46). The movement control unit 32 starts a countdown after setting the effective time To in the timer, starts measuring the effective period an operation by an acoustic feature (step S47), and ends the processing.

Meanwhile, in a case where the operation type is the drag correction, the movement control unit 32 moves the operation target at a fixed speed or a speed corresponding to the acoustic feature (step S48). The movement control unit 32 determines whether or not the utterance of the acoustic feature of the drag correction has ended (step S49). In a case where the utterance of the acoustic feature of the drag correction has not ended (step S49: No), the process proceeds to step 348 described above. On the other hand, in a case where the utterance of the acoustic feature of the drag correction has ended (step S49: Yes), the process proceeds to step S46 described above.

According to this acoustic feature operation processing, it is possible to perform processing of a command for moving an operation target while reducing the operation load.

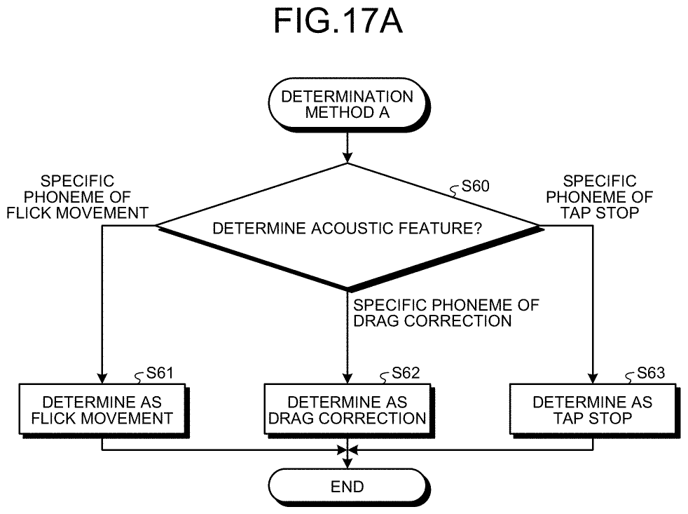

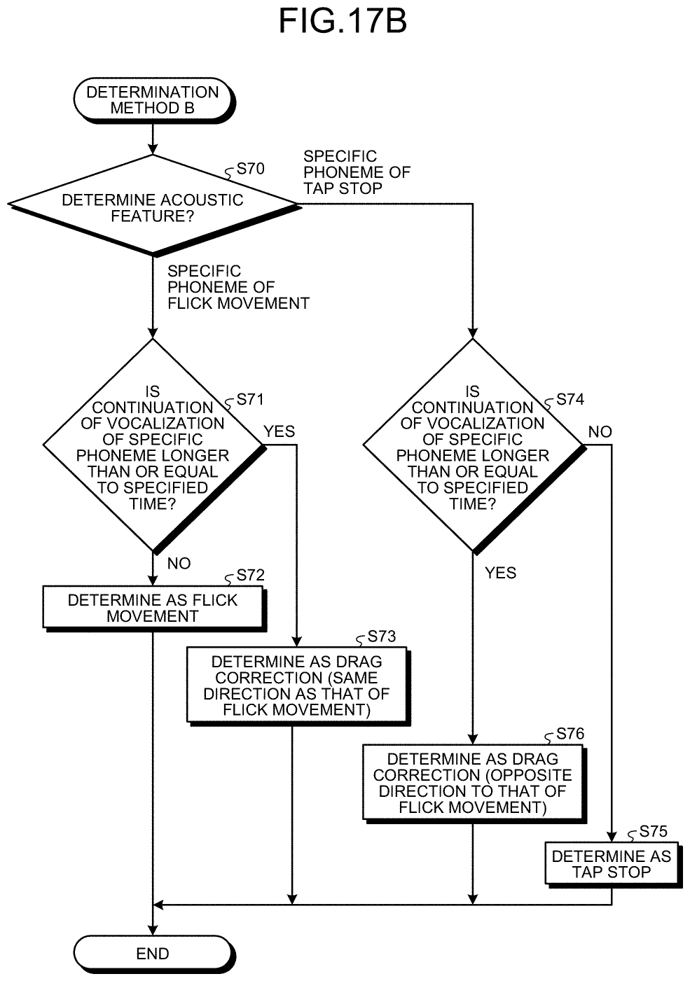

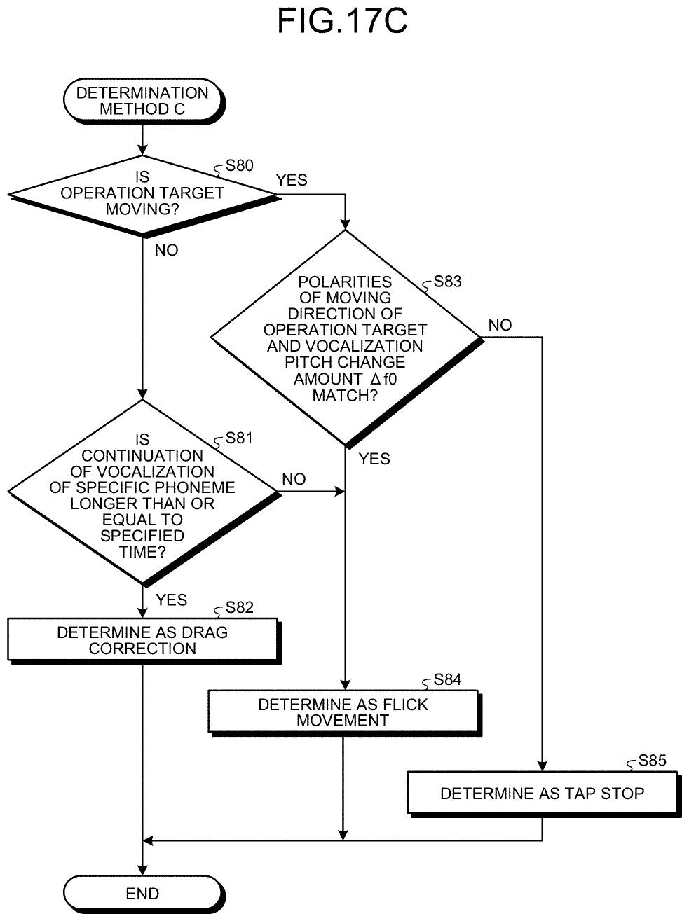

Next, the operation type determination processing performed in step S41 of the acoustic feature operation processing will be described. Here, the operation type determination processing corresponding to each of the determination methods A to C will be individually described. FIG. 17A is a flowchart illustrating the operation type determination processing in the determination method A according to the embodiment of the present disclosure.

The movement control unit 32 determines whether the detected acoustic feature is any one of a specific phoneme of flick movement, a specific phoneme of tap stop, and a specific phoneme of drag correction (step S60).

In a case where the detected acoustic feature is a specific phoneme of flick movement, the movement control unit 32 determines the operation type as flick movement (step 361) and ends the processing. In addition, in a case where the detected acoustic feature is a specific phoneme of drag correction, the movement control unit 32 determines the operation type as drag correction (step S62) and ends the processing. In addition, in a case where the detected acoustic feature is a specific phoneme of tap stop, the movement control unit 32 determines the operation type as tap stop (step S63) and ends the processing.

FIG. 173 is a flowchart illustrating the operation type determination processing in the determination method B according to the embodiment of the present disclosure.

The movement control unit 32 determines whether the detected acoustic feature is any one of a specific phoneme of flick movement and a specific phoneme of tap stop (step S70).

In a case where the detected acoustic feature is a specific phoneme of flick movement, the movement control unit 32 determines whether or not the utterance of the specific phoneme of the flick movement is longer than or equal to a specified time (step S71). In a case where the utterance is not longer than or equal to the specified time (step S71: No), the movement control unit 32 determines the operation type as flick movement (step S72), and ends the processing. On the other hand, in a case where the utterance is longer than or equal to the specified time (step S71: Yes), the movement control unit 32 determines the operation type as drag correction in the same direction as the direction of the flick movement (step S73), and ends the processing.

In a case where the detected acoustic feature is a specific phoneme of tap stop, the movement control unit 32 determines whether or not the utterance of the specific phoneme of the tap stop is longer than or equal to a specified time (step S74). In a case where the utterance is not longer than or equal to the specified time (step S74: No), the movement control unit 32 determines that the operation type is tap stop (step S75), and ends the processing. On the other hand, in a case where the utterance is longer than or equal to the specified time (step S74: Yes), the movement control unit 32 determines that the operation type is drag correction in a direction opposite to the direction of the flick movement (step S76), and ends the processing.

FIG. 17C is a flowchart illustrating the operation type determination processing in the determination method C according to the embodiment of the present disclosure.

The movement control unit 32 determines whether or not the operation target is moving (step S80). In a case where the operation target is stopped and is not moving (step S80: No), the movement control unit 32 determines whether or not utterance of a specific phoneme is longer than or equal to a specified time (step S81). In a case where the utterance is longer than or equal to the specified time (step S81: Yes), the movement control unit 32 determines that the operation type is drag correction (step S82), and ends the processing. On the other hand, in a case where the utterance is not longer than or equal to the specified time (step S81: No), the movement control unit 32 determines that the operation type is flick movement (step S84), and ends the processing.

Meanwhile, in a case where the operation target is moving (step S80: Yes), the movement control unit 32 determines whether or not the polarities of the moving direction of the operation target and the unit time change amount Δf0 of the pitch of the vocalization match (step S83). In a case where the polarities match (step S83: Yes), the movement control unit 32 determines that the operation type is flick movement (step S84), and ends the processing. On the other hand, in a case where the polarities do not match (step S83: No), the movement control unit 32 determines that the operation type is tap stop (step S85), and ends the processing.

### 3. Effects of Embodiment

As described above, the information processing apparatus 10 according to the embodiment includes the acoustic feature detection unit 31 and the movement control unit 32. The acoustic feature detection unit 31 detects acoustic features of voice discretely input separately from a command instructing movement of an operation target. The movement control unit 32 controls the movement of the operation target instructed by the command on the basis of the acoustic features detected by the acoustic feature detection unit 31. As a result, the information processing apparatus 10 can perform processing of the command while reducing the operation load.

In addition, in a case where an acoustic feature is detected by the acoustic feature detection unit 31 during a period of a predetermined first time (effective time To) after the command is input, the movement control unit 32 controls the movement of the operation target instructed by the command on the basis of the acoustic feature. As a result, the information processing apparatus 10 can prevent the operation target from moving by detecting noise.

In addition, the acoustic feature is at least one of presence or absence of a specific phoneme of voice, a maximum volume of a specific phoneme, a vocalization start interval of a specific phoneme, a pitch of a specific phoneme, a rising/falling polarity of the pitch, a change amount of the pitch, an onomatopoeia, a strength of a strained sound, a fricative, a volume of a fricative, and a tongue clicking sound. As a result, the information processing apparatus 10 can operate the operation target by voice.

In addition, the acoustic feature detection unit 31 detects a first acoustic feature and a second acoustic feature different from the first acoustic feature from discretely input voice. In a case where the first acoustic feature is detected, the movement control unit 32 increases the moving speed of the operation target, and frictionally decelerates the operation target while the first acoustic feature and the second acoustic feature are not detected. As a result, the information processing apparatus 10 can enable flick movement of the operation target by the first acoustic feature. In addition, in a case where the second acoustic feature is detected, the movement control unit 32 performs control to stop the operation target. As a result, the information processing apparatus 10 can enable tap stop of the operation target by the second acoustic feature.

In addition, the acoustic feature detection unit 31 detects a third acoustic feature different from the first acoustic feature and the second acoustic feature from discretely input voice. In a case where the third acoustic feature is detected, the movement control unit 32 performs control to move the operation target at a fixed speed or a speed corresponding to the third acoustic feature during the continuation of the voice of the third acoustic feature. As a result, the information processing apparatus 10 can enable drag correction of the operation target by the third acoustic feature.

In addition, the command is input by voice. The first acoustic feature is a phoneme included in a voice command instructing movement. The second acoustic feature is a phoneme included in a voice command instructing stop. As a result, the information processing apparatus 10 can enable flick movement and tap stop by a phoneme included in a voice command instructing movement and a phoneme included in a voice command instructing stop.

In addition, the command is input by voice. The first acoustic feature is a rise in pitch. The second acoustic feature is a fall in pitch. As a result, the information processing apparatus 10 can perform flick movement and tap stop by rise or fall in pitch of a voice.

In addition, the acoustic feature detection unit 31 further detects an onomatopoeia expressing friction from discretely input voice. in a case where an onomatopoeia expressing friction is detected, the movement control unit 32 performs control to increase the frictional deceleration of the operation target while the onomatopoeia is detected. As a result, the information processing apparatus 10 can adjust the moving speed or the stop position of the operation target by the onomatopoeia expressing the friction, and can provide the user with an easy-to-understand operation using the onomatopoeia expressing the friction.

In addition, the acoustic feature detection unit 31 detects an onomatopoeia expressing a movement state from discretely input voice. In a case where an onomatopoeia expressing a movement state is detected, the movement control unit 32 performs control to move the operation target by changing the increase amount for increasing the moving speed of the operation target and the degree of frictional deceleration according to the type of the detected onomatopoeia. As a result, the information processing apparatus 10 can operate the operation target corresponding to the expression of the onomatopoeia, and can provide the user with an easy-to-understand operation using the onomatopoeia expressing the movement state.

In addition, the information processing apparatus 10 further includes the display unit 11. The display unit 11 displays the arrival point to be reached by the movement operation of the operation target together with the current state of the operation target. As a result, the information processing apparatus 10 can present the user with the arrival point at which the operation target arrives by movement together with the current state of the operation target.

In addition, the display unit 11 visually presents the current moving speed of the operation target. As a result, the information processing apparatus 10 can present the user with the current moving speed of the operation target.

In addition, the information processing apparatus 10 further includes the display unit 11, the photographing unit 12, and the image recognition unit 36. The display unit 11 displays the operation target. The photographing unit 12 photographs the user who inputs the command. The image recognition unit 36 detects at least one of the direction of the face and the line of sight of the user from the image photographed by the photographing unit 12. The movement control unit 32 determines whether the user is looking at the display unit 11 from at least one of the direction of the face and the line of sight detected by the image recognition unit 36 when the command is input, and controls the movement of the operation target instructed by the command on the basis of the acoustic feature detected by the acoustic feature detection unit 31 in a case where the user is looking at the display unit 11. As a result, the information processing apparatus 10 can perform the operation of the acoustic feature in a case where the user is looking at the operation target, and can improve the noise resistance.

The preferred embodiments of the present disclosure have been described in detail above with reference to the accompanying drawings, but the present technique is not limited to such examples. It is obvious that a person having ordinary knowledge in the technical field of the present disclosure can conceive various changes or modifications within the scope of the technical ideas described in the claims, and it is naturally understood that these also belong to the technical scope of the present disclosure.

In addition, all or part of each processing described in the present embodiment may be implemented by causing a processor such as a CPU included in the information processing apparatus 10 and the server apparatus 20 to execute a program corresponding to each processing. For example, a program corresponding to each processing in the above description may be stored in a memory, and the program may be read from the memory and executed by a processor. In addition, the program may be stored in a program server connected to at least one of the information processing apparatus 10 and the server apparatus 20 via an arbitrary network, downloaded to at least one of the information processing apparatus 10 and the server apparatus 20, and executed. In addition, the program may be stored in a recording medium readable by either the information processing apparatus 10 or the server apparatus 20, read from the recording medium, and executed. Examples of the recording medium includes, for example, a portable storage medium such as a memory card, a USB memory, an SD card, a flexible disk, a magneto-optical disk, a CD-ROM, a DVD, and a Blu-ray (registered trademark) disk. In addition, the program is a data processing method described in an arbitrary language or an arbitrary description method, and may be in any format such as a source code or a binary code. In addition, the program is not necessarily limited to a single program, and includes a program configured in a distributed manner as a plurality of modules or a plurality of libraries, or a program that achieves a function thereof in cooperation with a separate program represented by an OS.

In addition, the effects described in the present specification are merely illustrative or exemplary, and are not restrictive. That is, the technique according to the present disclosure can exhibit other effects obvious to those skilled in the art from the description of the present specification together with or instead of the above effects.

In addition, the disclosed technique can also adopt the following configurations.

(1)

An information processing apparatus comprising:

an acoustic feature detection unit configured to detect an acoustic feature of voice discretely input separately from a command instructing movement of an operation target; and

a movement control unit configured to control the movement of the operation target instructed by the command on the basis of the acoustic feature detected by the acoustic feature detection unit.

(2)

The information processing apparatus according to (1), wherein

in a case where an acoustic feature is detected by the acoustic feature detection unit during a period of a predetermined first time after the command is input, the movement control unit controls the movement of the operation target instructed by the command on the basis of the acoustic feature.

(3)

The information processing apparatus according to (1) or (2), wherein

the acoustic feature is at least one of presence or absence of a specific phoneme of the voice, a maximum volume of a specific phoneme, a vocalization start interval of a specific phoneme, a pitch of a specific phoneme, a rising/falling polarity of the pitch, a change amount of the pitch, an onomatopoeia, a strength of a strained sound, a fricative, a volume of a fricative, and a tongue clicking sound.

(4)

The information processing apparatus according to any one of (1) to (3), wherein

the acoustic feature detection unit detects a first acoustic feature and a second acoustic feature different from the first acoustic feature from the voice discretely input, and

the movement control unit performs control to increase a moving speed of the operation target in a case where the first acoustic feature is detected, frictionally decelerate the operation target while the first acoustic feature and the second acoustic feature are not detected, and stop the operation target in a case where the second acoustic feature is detected.

(5)

The information processing apparatus according to (4), wherein

the acoustic feature detection unit detects a third acoustic feature different from the first acoustic feature and the second acoustic feature from the voice discretely input, and

in a case where the third acoustic feature is detected, the movement control unit performs control to move the operation target at a fixed speed or a speed corresponding to the third acoustic feature during continuation of the voice of the third acoustic feature.

(6)

The information processing apparatus according to (4), wherein

the command is input by voice,

the first acoustic feature is a phoneme included in a voice command instructing movement, and

the second acoustic feature is a phoneme included in a voice command instructing stop.

(7)

The information processing apparatus according to (4), wherein

the command is input by voice,

the first acoustic feature is a rise in pitch, and

the second acoustic feature is a fall in pitch.

(8)

The information processing apparatus according to any one of (4) to (7), wherein

the acoustic feature detection unit further detects an onomatopoeia expressing friction from the voice discretely input, and

in a case where the onomatopoeia expressing the friction is detected, the movement control unit performs control to increase frictional deceleration of the operation target while the onomatopoeia is detected.

(9)

The information processing apparatus according to any one of (1) to (8), wherein

the acoustic feature detection unit detects an onomatopoeia expressing a movement state from the voice discretely input, and

in a case where the onomatopoeia expressing the movement state is detected, the movement control unit performs control to move the operation target by changing an increase amount for increasing a moving speed of the operation target and a degree of frictional deceleration according to a type of the onomatopoeia detected.

(10)

The information processing apparatus according to any one of (1) to (9), further comprising

a display unit configured to display an arrival point to be reached by a movement operation of the operation target together with a current state of the operation target.

(11)

The information processing apparatus according to (10), wherein

the display unit visually presents a current moving speed of the operation target.

(12)

The information processing apparatus according to any one of (1) to (11), further comprising:

a display unit configured to display the operation target;

a photographing unit configured to photograph a user who inputs a command; and

an image recognition unit configured to detect at least one of a direction of a face and a line of sight of the user from an image photographed by the photographing unit, wherein

the movement control unit determines whether the user is looking at the display unit from at least one of the direction of the face and the line of sight detected by the image recognition unit when the command is input, and controls the movement of the operation target instructed by the command on the basis of the acoustic feature detected by the acoustic feature detection unit in a case where the user is looking at the display unit.

(13)

A command processing method, wherein

a computer is configured to:

detect an acoustic feature of voice discretely input separately from a command instructing movement of an operation target; and

control the movement of the operation target instructed by the command on the basis of the acoustic feature detected.

### REFERENCE SIGNS LIST

1 INFORMATION PROCESSING SYSTEM
10 INFORMATION PROCESSING APPARATUS
11 DISPLAY UNIT
12 PHOTOGRAPHING UNIT
13 VOICE OUTPUT UNIT
14 VOICE INPUT UNIT
15 STORAGE UNIT
16 COMMUNICATION UNIT
17 CONTROL UNIT
20 SERVER APPARATUS
21 COMMUNICATION UNIT
22 STORAGE UNIT
23 CONTROL UNIT
30 UTTERANCE SECTION DETECTION UNIT
31 ACOUSTIC FEATURE DETECTION UNIT
32 MOVEMENT CONTROL UNIT
33 OUTPUT CONTROL UNIT
34 VOICE RECOGNITION UNIT
35 SEMANTIC UNDERSTANDING UNIT
36 IMAGE RECOGNITION UNIT
40 CONTENT DATA

1. An information processing apparatus comprising:
an acoustic feature detection unit configured to detect an acoustic feature of voice discretely input separately from a command instructing movement of an operation target; and
a movement control unit configured to control the movement of the operation target instructed by the command on the basis of the acoustic feature detected by the acoustic feature detection unit.

2. The information processing apparatus according to claim 1, wherein
in a case where an acoustic feature is detected by the acoustic feature detection unit during a period of a predetermined first time after the command is input, the movement control unit controls the movement of the operation target instructed by the command on the basis of the acoustic feature.

3. The information processing apparatus according to claim 1, wherein
the acoustic feature is at least one of presence or absence of a specific phoneme of the voice, a maximum volume of a specific phoneme, a vocalization start interval of a specific phoneme, a pitch of a specific phoneme, a rising/falling polarity of the pitch, a change amount of the pitch, an onomatopoeia, a strength of a strained sound, a fricative, a volume of a fricative, and a tongue clicking sound.

4. The information processing apparatus according to claim 1, wherein
the acoustic feature detection unit detects a first acoustic feature and a second acoustic feature different from the first acoustic feature from the voice discretely input, and
the movement control unit performs control to increase a moving speed of the operation target in a case where the first acoustic feature is detected, frictionally decelerate the operation target while the first acoustic feature and the second acoustic feature are not detected, and stop the operation target in a case where the second acoustic feature is detected.

5. The information processing apparatus according to claim 4, wherein
the acoustic feature detection unit detects a third acoustic feature different from the first acoustic feature and the second acoustic feature from the voice discretely input, and
in a case where the third acoustic feature is detected, the movement control unit performs control to move the operation target at a fixed speed or a speed corresponding to the third acoustic feature during continuation of the voice of the third acoustic feature.

6. The information processing apparatus according to claim 4, wherein
the command is input by voice,
the first acoustic feature is a phoneme included in a voice command instructing movement, and
the second acoustic feature is a phoneme included in a voice command instructing stop.

7. The information processing apparatus according to claim 4, wherein
the command is input by voice,
the first acoustic feature is a rise in pitch, and
the second acoustic feature is a fall in pitch.

8. The information processing apparatus according to claim 4, wherein
the acoustic feature detection unit further detects an onomatopoeia expressing friction from the voice discretely input, and
in a case where the onomatopoeia expressing the friction is detected, the movement control unit performs control to increase frictional deceleration of the operation target while the onomatopoeia is detected.

9. The information processing apparatus according to claim 1, wherein
the acoustic feature detection unit detects an onomatopoeia expressing a movement state from the voice discretely input, and
in a case where the onomatopoeia expressing the movement state is detected, the movement control unit performs control to move the operation target by changing an increase amount for increasing a moving speed of the operation target and a degree of frictional deceleration according to a type of the onomatopoeia detected.

10. The information processing apparatus according to claim 1, further comprising
a display unit configured to display an arrival point to be reached by a movement operation of the operation target together with a current state of the operation target.

11. The information processing apparatus according to claim 10, wherein
the display unit visually presents a current moving speed of the operation target.

12. The information processing apparatus according to claim 1, further comprising:
a display unit configured to display the operation target;
a photographing unit configured to photograph a user who inputs a command; and
an image recognition unit configured to detect at least one of a direction of a face and a line of sight of the user from an image photographed by the photographing unit, wherein
the movement control unit determines whether the user is looking at the display unit from at least one of the direction of the face and the line of sight detected by the image recognition unit when the command is input, and controls the movement of the operation target instructed by the command on the basis of the acoustic feature detected by the acoustic feature detection unit in a case where the user is looking at the display unit.

13. A command processing method, wherein
a computer is configured to:
detect an acoustic feature of voice discretely input separately from a command instructing movement of an operation target; and
control the movement of the operation target instructed by the command on the basis of the acoustic feature detected.
